(19) United States
(12) Patent Application Publication
(10) Pub. No.: US 2026/0095960 A1
(43) Pub. Date: Apr. 2, 2026

(54) PDU SESSION MODIFICATION FOR A SUBSCRIBER ENTITY

(71) Applicant: Telefonaktiebolaget LM Ericsson (publ), Stockholm (SE)

(72) Inventors: Patrik SALMELA, Espoo (FI); Kazi Wali ULLAH, Espoo (FI); Patrik TEPPO, Bobäck (FI); Abu Shohel AHMED, Espoo (FI)

(21) Appl. No.: 19/113,198

(22) PCT Filed: Sep. 30, 2022
(86) PCT No.: PCT/EP2022/077264

§ 371 Date: Mar. 19, 2025

(51) Int. Cl. H04W 76/10; H04W 12/06; H04W 12/08

(52) U.S. Cl. CPC H04W 76/10; H04W 12/06; H04W 12/08

(57) ABSTRACT

There is provided techniques for using a PDU session to access application services. A method is performed by a subscriber entity. The method includes accessing a primary application service of a primary data network using a PDU session by first requesting the PDU session with the primary data network to be established. The method includes providing a request to an SMF entity for the PDU session to be modified for the subscriber entity to use the PDU session to access a secondary application service with a different access control policy than the primary application service. The method includes, in response thereto, performing a secondary authentication with an EAP server for the already established PDU session for the subscriber entity to access the secondary application service of the secondary data network.

### TECHNICAL FIELD

Embodiments presented herein relate to a method, a subscriber entity, a computer program, and a computer program product for the subscriber entity to use a protocol data unit session to access application services. Further embodiments presented herein relate to a method, a Session Management Function entity, a computer program, and a computer program product for enabling the subscriber entity to use the protocol data unit session to access application services. Further embodiments presented herein relate to a method, an Extensible Authentication Protocol server, a computer program, and a computer program product for performing secondary authentication with the subscriber entity.

### BACKGROUND

In communications networks, there may be a challenge to obtain good performance and capacity for a given communications protocol, its parameters and the physical environment in which the communications network is deployed.

For example, secondary authentication is a technique that is defined in the technical specification 3GPP TS 33.501 “Security architecture and procedures for 5G System” (latest version: 17.6.0) to facilitate authentication of a subscriber entity (as represented by a user equipment; UE) with a data network that is outside the operator network domain. To support this functionality, different Extensible Authentication Protocol (EAP) based authentication methods and associated credentials can be used. Typically, these are controlled, or managed, by the data network and not by the operator.

As defined in the aforementioned technical specification 3GPP TS 33.501 in section 11.1, the secondary authentication is triggered by a Session Management Function (SMF) upon receiving a request of a protocol data unit (PDU) session establishment from the UE. This PDU session establishment process is by the UE requested to the SMF after the primary authentication for the UE has been concluded. The SMF then obtains necessary information from a Unified Data Management (UDM) to check the validity of this request and whether a secondary authentication is needed or not. If secondary authentication is required, the SMF triggers an EAP authentication with a data network (DN) authentication, authorization, and accounting (AAA) server. After the successful authentication between the UE and the DN-AAA server, a User Plane Function (UPF) and the SMF receives an EAP-success message from the DN-AAA server. This indicates a successful EAP authentication. Then the SMF continues the process of establishing the requested PDU session for the UE.

One purpose of the secondary authentication is to restrict access for the UE to a given data network (e.g., an enterprise network) to only legitimate users. UEs that cannot perform successfully secondary authentication towards the DN-AAA server would not be allowed to access that given data network.

The UE can, when requesting PDU session establishment, indicate the targeted external DN by indicating a target Data Network Name (DNN). The mobile network operator has policies with respect to which UEs are allowed to access specific DNs/DNNs as well as whether secondary authentication is required for the UEs to gain access to the DN. The DNN defines where the UE is allowed/capable to connect using the PDU session established for the DNN. A DNN associated with an enterprise intranet could e.g., define that all traffic of the PDU session should be routed between the UE and a gateway of the enterprise network. For a public DNN, such as the Internet, the DNN could be configured to forward al traffic between the UE and the public network.

There are UE Route Selection Policy (URSP) rules that can be configured into the UE by the network. These rules are evaluated by the UE when an application run in the UE requests to access the network. Based on the rules, the suitable DNN, or PDU session, can be identified and either established or selected before the application can start using the network through it. This is described in section 6.6.2 in the technical specification 3GPP TS 23.503 “Policy and charging control framework for the 5G System (5GS); Stage 2”(latest version: 17.5.0).

When there is an existing PDU session, the UE, or the network, can request modification of the PDU session using a PDU Session Modification Request Message. This can be used e.g., to modify quality of service (QoS) parameters for the PDU session or signaling joining or leaving of Multicast and Broadcast Services (MBS) sessions, see section 6.4.2.2 in the technical specification 3GPP TS 23.501 “Non-Access-Stratum (NAS) protocol for 5G System (5GS); Stage 3” (latest version: 17.7.1). The modification message is described in section 8.3.7 of the aforementioned technical specification 3GPP 24.501. The message has four mandatory parameters and can contain various optional parameters. The parameters are called information elements (IE). The mandatory parameters are: Extended protocol discriminator, PDU session identifier (ID), Procedure transaction ID, and message type. These parameters are used for keeping track of the protocol exchange and to identifying the message type (modification request) and the addressed session, i.e. information non-specific to the specific type of modification at hand. The optional IEs then carry the specific type of modification requested by the UE.

DNNs can be used for providing mobile network operator assisted access control to various DNs. When requesting a PDU session for a DNN, the UE, after being authorized to access the targeted DN, is assigned a PDU session linking the UE to the DN. This also results in the UE being assigned an Internet protocol (IP) address to be used in the PDU session. In a scenario where (e.g.) an enterprise wants to utilize mobile network operator capability to provide access control to an enterprise DN and service within, but wants to have different zones within the DN so that a UE is not automatically authorized to access all service in the enterprise DN, multiple DNNs for the enterprise are needed; one DNN for each separately access controlled set of service(s). This also means that the enterprise network would have to be split into separate DNs, linked to the corresponding DNNs. This is since each DN has its own DNN (and vice versa). This implies that the mobile network operator, the enterprise, as well as the UE would have to handle multiple contexts. The UE would have multiple PDU sessions with dedicated IP addresses and traffic would have to be routed to the correct PDU session to reach desired service(s). The mobile network operator would likewise have to maintain and manage multiple DNNs and PDU sessions and IP addresses. The enterprise would have to deploy multiple DNs. This is not efficient and can become complex.

### SUMMARY

An object of embodiments herein is to address the above issues.

A particular object is to simplify, in terms of implementational as well as operational complexity, the process for an enterprise to utilize mobile network operator supported access control (via secondary authentication and DNN) for different access rights levels to its DN services.

According to a first aspect there is presented a method for using a PDU session to access application services. The method is performed by a subscriber entity. The method comprises accessing a primary application service of a primary data network using a PDU session by first requesting the PDU session with the primary data network to be established. The method comprises providing a request to an SMF entity for the PDU session to be modified for the subscriber entity to use the PDU session to access a secondary application service with a different access control policy than the primary application service. The method comprises, in response thereto, performing a secondary authentication with an EAP server for the already established PDU session for the subscriber entity to access the secondary application service of the secondary data network.

According to a second aspect there is presented a subscriber entity for using a PDU session to access application services. The subscriber entity comprises processing circuitry. The processing circuitry is configured to cause the subscriber entity to access a primary application service of a primary data network using a PDU session by first requesting the PDU session with the primary data network to be established. The processing circuitry is configured to cause the subscriber entity to provide a request to an SMF entity for the PDU session to be modified for the subscriber entity to use the PDU session to access a secondary application service with a different access control policy than the primary application service. The processing circuitry is configured to cause the subscriber entity to, in response thereto, perform a secondary authentication with an EAP server for the already established PDU session for the subscriber entity to access the secondary application service of the secondary data network.

According to a third aspect there is presented a computer program for using a session to access application services, the computer program comprising computer program code which, when run on processing circuitry of a subscriber entity, causes the subscriber entity to perform a method according to the first aspect.

According to a fourth aspect there is presented a method for enabling a subscriber entity to use a PDU session to access application services. The method is performed by an SMF entity. The method comprises allowing the subscriber entity to use a PDU session to access a primary application service of a primary data network upon the PDU session with the primary data network is established for the subscriber entity.

The method comprises obtaining, from the subscriber entity, a request for the PDU session to be modified for the subscriber entity to use the PDU session to access a secondary application service with a different access control policy than the primary application service. The method comprises, in response thereto, allowing the subscriber entity to access the secondary application service upon having received verification that a secondary authentication with an EAP server for the already established PDU session has been performed for the subscriber entity, and upon having verified that the subscriber entity is allowed to use the PDU session for accessing the secondary application service.

According to a fifth aspect there is presented an SMF entity for enabling a subscriber entity to use a PDU session to access application services. The SMF entity comprises processing circuitry. The processing circuitry is configured to cause the SMF entity to allow the subscriber entity to use a PDU session to access a primary application service of a primary data network upon the PDU session with the primary data network is established for the subscriber entity. The processing circuitry is configured to cause the SMF entity to obtain, from the subscriber entity, a request for the PDU session to be modified for the subscriber entity to use the PDU session to access a secondary application service with a different access control policy than the primary application service. The processing circuitry is configured to cause the SMF entity to, in response thereto, allow the subscriber entity to access the secondary application service upon having received verification that a secondary authentication with an EAP server for the already established PDU session has been performed for the subscriber entity, and upon having verified that the subscriber entity is allowed to use the PDU session for accessing the secondary application service.

According to a sixth aspect there is presented a computer program for enabling a subscriber entity to use a PDU session to access application services, the computer program comprising computer program code which, when run on processing circuitry of an SMF entity 300, causes the SMF entity to perform a method according to the fourth aspect.

According to a seventh aspect there is presented a method for performing secondary authentication with a subscriber entity. The method is performed by an EAP server. The method comprises performing secondary authentication for the subscriber entity for an already established PDU session. The PDU session was established for the subscriber entity to use the PDU session to access a primary application service of a primary data network, and wherein the secondary authentication is performed for the subscriber entity to use the PDU session to access a secondary application service with a different access control policy than the primary application service.

According to an eighth aspect there is presented an EAP server for performing secondary authentication with a subscriber entity. The EAP server comprises processing circuitry. The processing circuitry is configured to cause the EAP server to perform secondary authentication for the subscriber entity for an already established PDU session. The PDU session was established for the subscriber entity to use the PDU session to access a primary application service of a primary data network, and wherein the secondary authentication is performed for the subscriber entity to use the PDU session to access a secondary application service with a different access control policy than the primary application service.

According to a tenth aspect there is presented a computer program for performing secondary authentication with a subscriber entity, the computer program comprising computer program code which, when run on processing circuitry of an EAP server 400, causes the EAP server to perform a method according to the seventh aspect.

According to an eleventh aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously, these aspects require less implementational and operational complexity where an enterprise wants to utilize mobile network operator supported access control (via secondary authentication and DNN) for different access rights levels to its DN services.

Advantageously, these aspects do not require multiple DNNs for one and the same enterprise.

Advantageously, these aspects make it possible to use a single PDU session, and IP address, to access multiple DNs (or multiple parts of a single DN) in a controlled manner.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic illustration of an data network according to embodiments;

FIGS. 3, 4, and 5 are flowcharts of methods according to embodiments;

FIG. 6 is a signalling diagram according to an embodiment;

FIG. 7 is a schematic diagram showing functional units of a subscriber entity according to an embodiment;

FIG. 8 is a schematic diagram showing functional modules of a subscriber entity according to an embodiment;

FIG. 9 is a schematic diagram showing functional units of an SMF entity according to an embodiment;

FIG. 10 is a schematic diagram showing functional modules of an SMF entity according to an embodiment;

FIG. 11 is a schematic diagram showing functional units of an EAP server according to an embodiment;

FIG. 12 is a schematic diagram showing functional modules of an EAP server according to an embodiment; and

FIG. 13 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

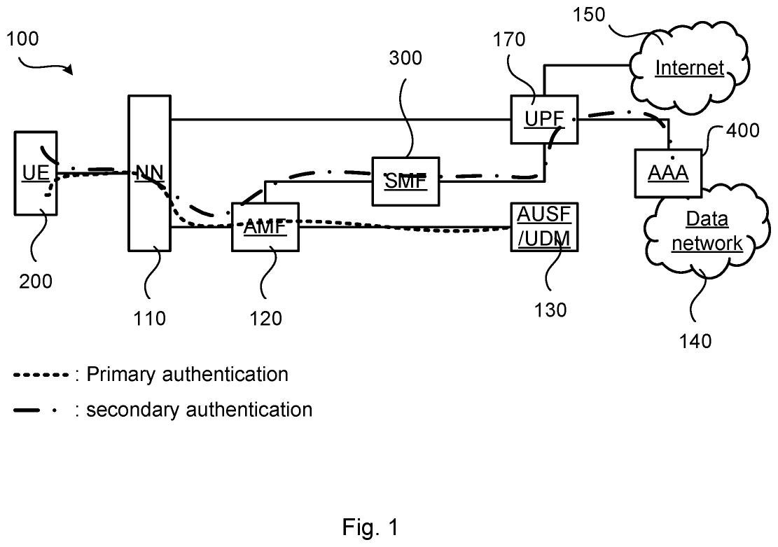

FIG. 1 is a schematic diagram illustrating a communication network 100 where embodiments presented herein can be applied. Only those network entities of relevance for the present disclosure are illustrated in FIG. 1. As is understood, the communication network 100 comprises further entities in addition to those illustrated. The communication network 100 comprises a network node 120 to which a subscriber entity 200, in terms of a user equipment (UE), is operatively connected. The network node 120 could be any, or any combination, of a (radio) access network node, radio base station, base transceiver station, node B, evolved node B, gNB, access point, access node, integrated access and backhaul node. The subscriber entity 200 might be provided in any of a portable wireless device, mobile station, mobile phone, handset, wireless local loop phone, smartphone, laptop computer, tablet computer, wireless modem, wireless sensor device, unmanned vehicle, Internet of Things device, or the like. The communication network 100 further comprises an Access and Mobility management Function (AMF) 120, an Authentication Server Function (AUSF) and a UDM (for illustrative purposes placed in one and the same node 130 but implementing different functions), a data network 140, a public data network 150, such as the Internet, a UPF 170, an SMF entity 300. And an EAP server 400 (also referred to as DN-AAA server),

According to at least some of the herein disclosed embodiments, a new type of PDU session modification request is used to add additional DNNs to an established PDU session (so as to modify the PDU session based on what service or network the UE wants to access). An example is a PDU session established for a DNN which initially provides limited access to the DN, where at a later stage more DNNs are added to the PDU session to include further parts of the DN, i.e., extending the access rights of the UE through the PDU session to the DN.

In this respect, the DN might be regarded as being logically split into multiple DNs, with the additional sub-DNs being assigned sub-DNNs. When the UE first requests a PDU session for the primary DNN, it gets access to a subset of all services in that DN. As part of the configuration of the primary DNN, the UPF uses firewall rules to limit which services are reachable using the primary DNN. Later, the UE can request a sub-DNN to be added to the existing PDU session, resulting in that targeted part(s) of the split DN are added to the existing PDU session. The firewall rules used by the UPF will, based on successful secondary authentication for these sub-DNNs, be modified to add selected services to the allowed list. An alternative is to have a PDU session established for a certain DNN (e.g., of an enterprise DN), and then later add a sub-DNN, which could be for a totally different DN (e.g., of a public network such as the Internet), to the PDU session and thereby having access to both primary DNN (of the enterprise DN) and the sub-DNN (of the public network) using the same PDU session. In this case there might not be any additional firewall rules involved as in the split-DN scenario.

The embodiments disclosed herein in particular relate to techniques for a subscriber entity 200 to use a PDU session to access application services and for secondary authentication to be performed for the subscriber entity 200. In order to obtain such techniques there is provided a subscriber entity 200, a method performed by the subscriber entity 200, a computer program product comprising code, for example in the form of a computer program, that when run on processing circuitry of the subscriber entity 200, causes the subscriber entity 200 to perform the method. In order to obtain such techniques there is further provided an SMF entity 300, a method performed by the SMF entity 300, and a computer program product comprising code, for example in the form of a computer program, that when run on processing circuitry of the SMF entity 300, causes the SMF entity 300 to perform the method. In order to obtain such techniques there is further provided an EAP server 400, a method performed by the EAP server 400, and a computer program product comprising code, for example in the form of a computer program, that when run on processing circuitry of the EAP server 400, causes the EAP server 400 to perform the method.

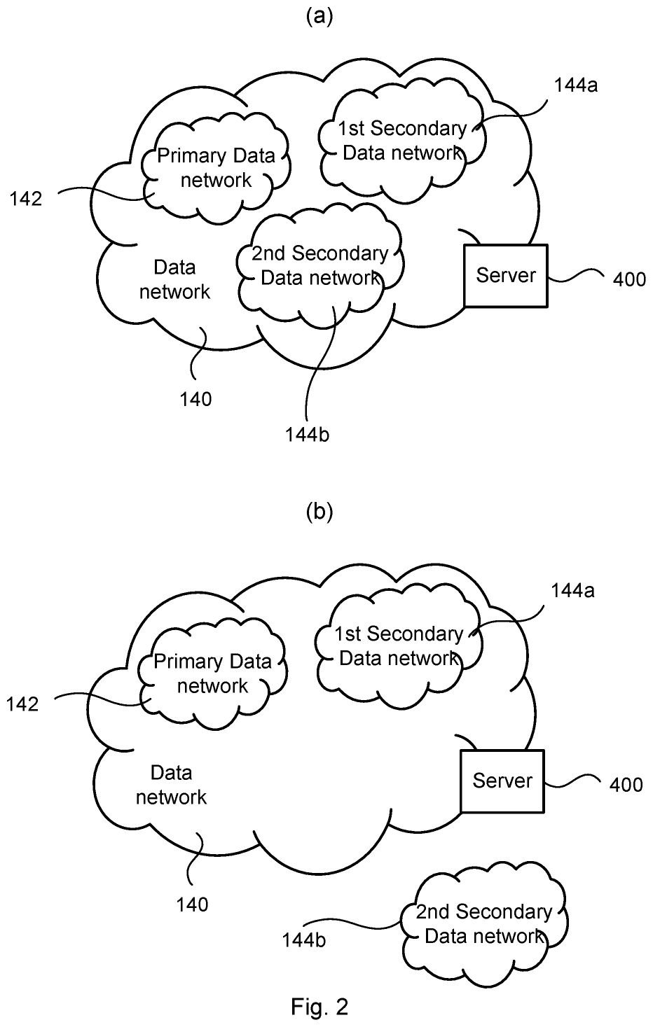

Consider a scenario where there is a primary DNN and one or more sub-DNNs. In general, the primary DNN would typically have firewall rules for blocking certain parts of the DN to which the DNN is associated. This would be comparable to a traditional DNN where all services in the DN are allowed to be reached and thus there would not be any blocking firewall rules. However, when there is need for access control within the DNN, then some parts of the DN can be blocked with these firewall rules. The sub-DNNs could be regarded as add-ons for the DN. The sub-DNNs could typically have allow type of firewall rules, stating which services are allowed when the sub-DNN is activated, or added to the PDU session for the primary DNN. There could be a mix of block/allow type of firewall rules for both the primary DNN and the sub-DNNs. Furthermore, the primary DNN and the sub-DNNs might not even be related or pertain to the same DN. This is illustrated in FIG. 2. In each of FIG. 2(a) and FIG. 2(b) is illustrated details of the data network 140, where the data network 140 comprises a primary data network 142 and one or more secondary data networks 144a, 144b. In this respect, FIG. 2(a) schematically illustrates an example where two secondary data networks 144a, 144b of the primary data network 142 are provided within the same data network 140. FIG. 2(b) schematically illustrates an example where one secondary data network 144a of the primary data network 142 is provided within the data network 140 and where another secondary data network 144b is provided outside the actual data network 140. The secondary data network 144b could be a subnetwork of the primary data network 142 or of another data network, e.g. the Internet.

The services of the primary DNN and the sub-DNN parts of the DN might in some examples be distinguishable by IP addressing. For example, assuming that the DN is using a private address space of 10.0.0.0/8, the DN could define that services requiring a certain sub-DNN to be active would have its own subnetwork from the DN network, e.g. primary DNN services reachable on IPs 10.1.0.0/16, and for a specific sub-DNN the services are located in 10.2.0.0./16, for another sub-DNN 10.3.0.0/16 would be used, etc. The services reachable per sub-DNN and primary DNN could also be listed as individual firewall rules.

As an introductory and non-limiting example, assume a scenario where an data network hosts three services, denoted service A, service B, and service C. Assume further that service A and service B could be reachable by authorized subscriber entities requesting access to a given DNN. However, whilst being part of the same DN, service C is not reachable via this DNN. Instead, if a subscriber entity wants to access service C, the subscriber entity needs to be authorized to access DNN specific for service C, i.e., a sub-DNN. In one alternative, the sub-DNN is strictly linked with the primary DNN. That is, to access the sub-DNN the subscriber entity first has to have access to the primary DNN. In alternative, the sub-DNN is considered as a separate DNN, which can be combined with the primary-DNN but could also be used on its own. With the strictly-linked approach, higher level of security can be provided as accessing a sub-DNN, which typically would host more sensitive data/services, would require multiple steps and possible types of authentication (possibly at the cost of user convenience).

In general terms, although the modification of the PDU session as will be disclosed hereinafter pertains to using a PDU session to access a further, secondary, application service, it is understood that the modification could also pertain to removing a previously added application service. That is, a modification request could be used to request the further, secondary, application service (or sub-DNN) be added to the PDU session, or that the further, secondary, application service (or sub-DNN) is to be removed from the PDU session. Such removal might not require any further action from the subscriber entity 200. As an example, any PDU session might have an expiry time. One non-limiting way to realize this is to use token-based authentication, where the token has an expiry time that defines the end of the PDU session. As policy rules can be used for controlling access of the PDU session, such policy rules could be time bound or some way restricted. It is therefore understood that the below aspects and embodiments are applicable also where a previously added application service is to be removed.

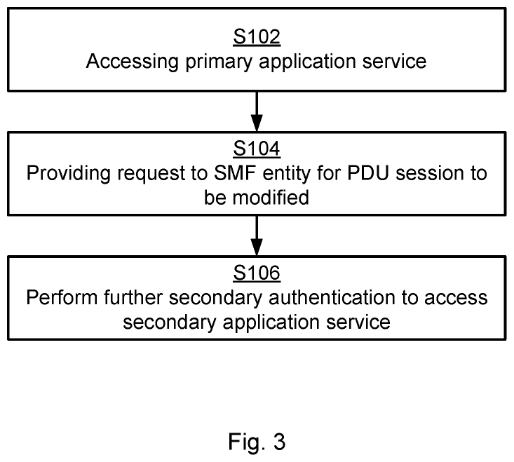

Reference is now made to FIG. 3 illustrating a method for using a PDU session to access application services as performed by the subscriber entity 200 according to an embodiment.

S102: The subscriber entity 200 accesses a primary application service of a primary data network 142 using a PDU session by first requesting the PDU session with the primary data network 142 to be established.

S104: The subscriber entity 200 provides a request to an SMF entity 300 for the PDU session to be modified for the subscriber entity 200 to use the PDU session to access a secondary application service with a different access control policy than the primary application service.

S106: The subscriber entity 200, in response thereto, performs a secondary authentication with an EAP server 400 for the already established PDU session for the subscriber entity 200 to access the secondary application service of the secondary data network 144a, 144b.

Embodiments relating to further details of using a PDU session to access application services as performed by the subscriber entity 200 will now be disclosed.

In some examples, the secondary authentication is a further secondary authentication, and a first secondary authentication is performed with the EAP server 400 for accessing the primary application service.

In some examples, the secondary application service is of a secondary data network 144a, 144b.

As disclosed above, in some aspects the DN is logically split into multiple DNs with the additional sub-DNs being assigned sub-DNNs. In particular, in some embodiments, the secondary data network 144a, 144b is a sub-data network of the primary data network 142.

In some aspects, the PDU session modification request comprises a dedicated information element (IE) for providing sub-DNN type of information, at least including a sub-DNN identifier, or name. In particular, in some embodiments, the request for the PDU session to be modified for the subscriber entity 200 is provided in a PDU session modification request, and the PDU session modification request comprises an IE for at least holding information identifying the secondary data network 144a, 144b.

In some aspects, the IE carries a variable indicating the type of operation that is requested. Hence, in some embodiments, the IE further holds information identifying that the secondary application service is requested to be accessed using the PDU session. Further, there might be an identifier identifying the IE as being of sub-DNN type. This can be achieved by giving the IE a dedicated IE identifier that is meant for providing sub-DNN type of information. The data carried by the IE might include at least the sub-DNN identifier/name, basically an identifier for the sub-DNN. Further, the IE might carry a variable indicating the type of operation that is requested, with possible values being “add” and “remove”. As noted above, typically, the subscriber entity 200 would request to add the sub-DNN to the current PDU session. However, there could be scenarios where the subscriber entity 200 might want to remove a sub-DNN once the subscriber entity 200 is done with using the services reachable via the sub-DNN. The IE could possibly be encoded in an already existing IE, with using some field of the IE to indicate that this is actually a sub-DNN ID and thus the SMF entity 300 would be able to parse the sub-DNN information from the IE. Alternatively, the IE could define a new sub-DNN IE.

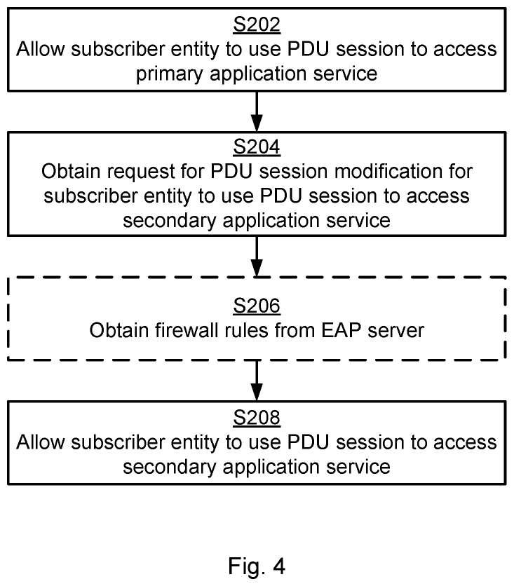

Reference is now made to FIG. 4 illustrating a method for enabling a subscriber entity 200 to use a PDU session to access application services as performed by the SMF entity 300 according to an embodiment.

S202: The SMF entity 300 allows the subscriber entity 200 to use a PDU session to access a primary application service of a primary data network 142 upon the PDU session with the primary data network 142 being established for the subscriber entity 200.

S204: The SMF entity 300 obtains, from the subscriber entity 200, a request for the PDU session to be modified for the subscriber entity 200 to use the PDU session to access a secondary application service with a different access control policy than the primary application service.

S208: The SMF entity 300, in response thereto, allows the subscriber entity 200 to access the secondary application service upon having received verification that a secondary authentication with an EAP server 400 for the already established PDU session has been performed for the subscriber entity 200, and upon having verified that the subscriber entity 200 is allowed to use the PDU session for accessing the secondary application service.

Embodiments relating to further details of enabling a subscriber entity 200 to use a PDU session to access application services as performed by the SMF entity 300 will now be disclosed.

In some examples, the secondary authentication is a further secondary authentication, and a first secondary authentication has been performed with the EAP server 400 for the subscriber entity 200 (for example as part of establishing the PDU session).

In some examples, the secondary application service is of a secondary data network 144a, 144b.

In some examples, the verification that the secondary authentication with the EAP server 400 for the already established PDU session has been performed for the subscriber entity 200 is received from the EAP server 400.

In some aspects, there are firewall rules for blocking certain parts of the DN to which the DNN is associated. The verification that the subscriber entity 200 is allowed to use the PDU session for accessing the secondary application service might then be obtained by checking such firewall rules. Hence, in some embodiments, verifying that the subscriber entity 200 is allowed to use the PDU session for accessing the secondary application service comprises the SMF entity 300 to check policies for the PDU session.

The policies might be provided by the EAP server 400. Therefore, in some embodiments, the SMF entity 300 is configured to perform (optional) step S206.

S206: The SMF entity 300 obtains the policies from the EAP server 400.

Here, the policies might define firewall rules to be used by the SMF entity 300, and/or be provided as instructions to the SMF entity 300, For example, the EAP server 400 might not send implicit firewall rules, but rather information regarding which services (e.g., identified by an IP address) to be allowed after secondary authentication has been completed for the subscriber entity.

Further in this respect, the SMF entity 300 might to the EAP server 400 provide the DNN or sub-DNN name, or information. This enables the EAP server 400 to take this information into consideration when deciding on what EAP method to use (see below) and if the subscriber entity 200 should even be allowed to try to authenticate, e.g., based on subscriber entity identity or currently activated DNN and sub-DNNs). Packet Detection Rules and Forwarding Action Rules can be used to act as firewall rules. During the PDU session establishment and the modification, the SMF entity 300 might set, modify, or update these rules accordingly. This will ensure which user plan traffic is allowed to reach the particular DN from a particular subscriber entity 200.

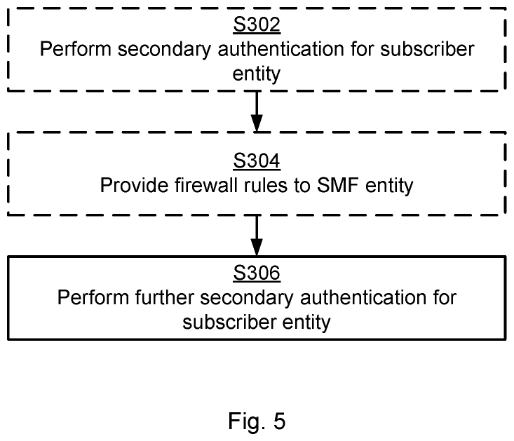

Reference is now made to FIG. 5 illustrating a method for performing secondary authentication with a subscriber entity 200 as performed by the EAP server 400 according to an embodiment.

S306: The EAP server 400 performs secondary authentication of the subscriber entity 200 for an already established PDU session (that is, a PDU session that has already been established for the subscriber entity 200). The PDU session was established for the subscriber entity 200 to use the PDU session to access a primary application service of a primary data network 142. The secondary authentication is performed for the subscriber entity 200 to use the PDU session to access a secondary application service with a different access control policy than the primary application service.

Embodiments relating to further details of performing secondary authentication with a subscriber entity 200 as performed by the EAP server 400 will now be disclosed.

In some examples, the secondary authentication is a further secondary authentication, and the EAP server 400 is configured to perform (optional) step S302.

S302: The EAP server 400 performs first secondary authentication for the subscriber entity 200 for the PDU session for the subscriber entity 200 to use the PDU session to access the primary application service.

In some examples, the secondary application service is of a secondary data network 144a, 144b.

By requiring different EAP methods for the secondary authentications to the different DNNs, stronger verification of the subscriber entity 200 can be achieved. Therefore, in some embodiments, the first secondary authentication and the further secondary authentication are performed using mutually different EAP methods. In this way, the secondary authentication could be different for different DNNs and/or different sub-DNNs. For example, the primary DNN could require password-based authentication, i.e., the EAP server 400 would require that the subscriber entity 200 is authenticated with a suitable EAP method, whilst the sub-DNN could have a different requirement with respect to the authentication (and thus EAP method), e.g., certificate-based, used. In further aspects, the EAP server 400 might for a new sub-DNN access request, through secondary authentication, select a suitable EAP method for the secondary authentication based on DNNs and/or sub-DNNs the subscriber entity 200 has requested previously for the ongoing PDU session. Hence, in some embodiments, which EAP method to use by the EAP server 400 when performing the secondary authentication with the subscriber entity 200 depends on which data networks for which the subscriber entity 200 has requested to use the PDU session.

Further, the EAP server 400 might allow different types of combinations of sub-DNNs whilst disallowing other combinations. That is, in some embodiments, the further secondary authentication depends on which other secondary data networks 144a, 144b or any other data network, if any, the subscriber entity 200 at the time of the further secondary authentication is using for the PDU session. In this case, if some sub-DNN cannot be removed, the subscriber entity 200 might not be able to reach some other sub-DNN which is conflicting with an already added sub-DNN. A concrete example could be that while the main DNN and a public sub-DNN such a “Internet” or “MBB” might be allowed to be enabled at the same time, it might be that the sub-DNN for service C (see above) is not allowed together with the public sub-DNN. In this case, the subscriber entity 200 might want to remove the public sub-DNN and then add the sub-DNN for service C.

As disclosed above, the EAP server 400 might use information of DNN or sub-DNN name, or information into consideration when deciding on what EAP method to use and if the subscriber entity 200 should even be allowed to try to authenticate, e.g., based on subscriber entity identity and/or currently activated DNN and sub-DNNs. That is, in some embodiments, whether the subscriber entity 200 is allowed to use the PDU session for accessing the secondary application service or not depends on policies for the PDU session.

As disclosed above, the policies might be provided to the SMF entity 300 by the EAP server 400. Therefore, in some embodiments, the EAP server 400 is configured to perform (optional) step S304.

S304: The EAP server 400 provides the policies to the SMF entity 300.

In some embodiments, the EAP server 400 is operated by a mobile network operator. In such a case the mobile network operator might have access to all the access policies etc., related to enterprise users. The EAP server 400 might then after successful secondary authentication still communicate with an entity in the data network to inform the data network of the mapping from IP address of the subscriber entity 200 to an identifier (could be multiple identifiers, such as GPSI, identifier authenticated with secondary authentication etc.) of the subscriber entity 200. The EAP server 400 might also inform about which DNN/sub-DNNs the of the subscriber entity 200 has been authenticated to and/or what services the subscriber entity 200 is authorized to access. The entity in the data network receiving this information could be a dedicated node for collecting this information or it could be a simplified EAP server only tasked with maintaining information about authentication of the subscriber entities 200 but not authenticating any subscriber entities 200 itself. In this case, the EAP server 400 in the data network could receive this type of information in a similar way as the EAP server 400 receives information in below steps S406 and S412 The EAP server in the mobile network operator network might even just forward the received messages directly to the EAP server 400 in the data network. The entity in the data network could utilize the received information e.g., as described in below described step S414.

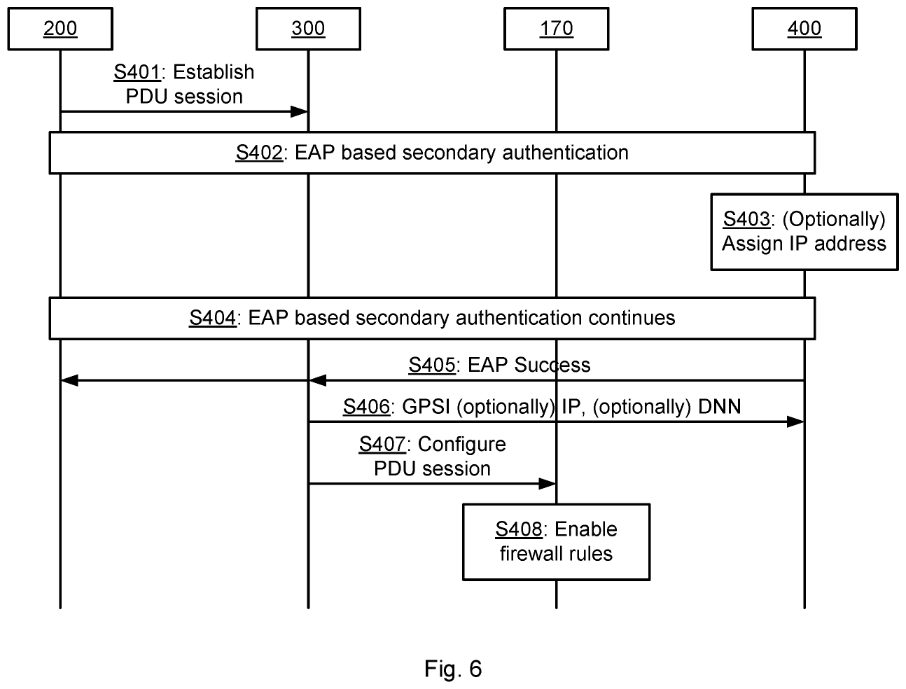

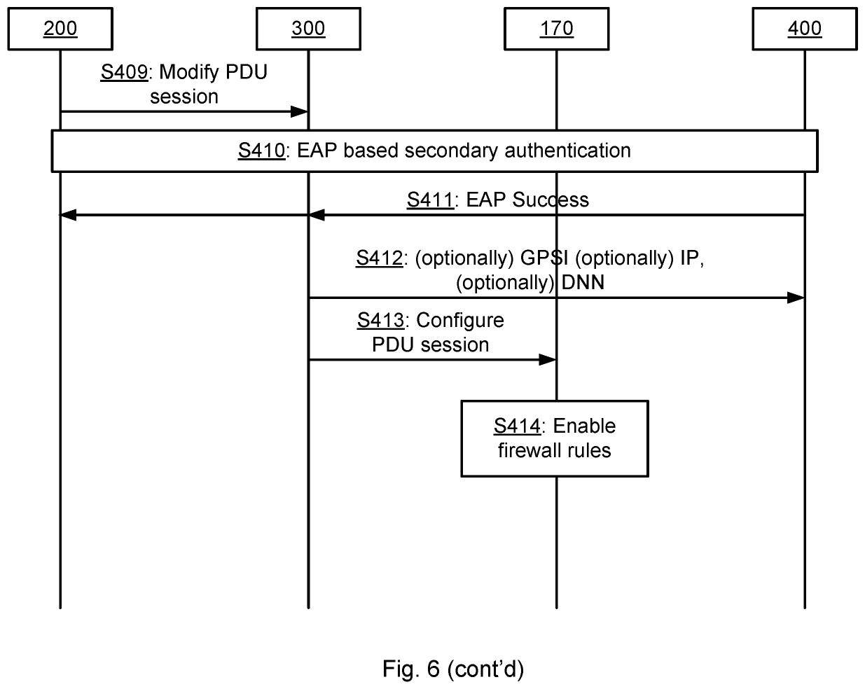

One particular embodiment for a subscriber entity 200 to use a PDU session to access application services and for secondary authentication to be performed for the subscriber entity 200 based on at least some of the above disclosed embodiments will now be disclosed in detail with reference to the signalling diagram of FIG. 6. For illustrative purposes, it is assumed that services A, B, C fulfil requirements as disclosed above.

S401: The subscriber entity 200 requests a new PDU session to be established and indicates the primary DNN of the enterprise. This DNN provides access to service A and service B.

S402: The SMF entity 300 handling the PDU session establishment request verifies that the subscriber entity 200 is authorized to request the DNN, and can then, if policy states so, initiate secondary authentication for the subscriber entity 200. The secondary authentication is run between the subscriber entity 200 and the EAP server 400, which in the present example is located in the data network. The SMF entity 300 can optionally inform the EAP server 400 the DNN the subscriber entity 200 has requested.

It is understood that the PDU session establishment request is initially received by an Access and Mobility management Function (AMF) from the subscriber entity 200 as a control channel message. The request is then forwarded to the SMF 300 that performs the actual session establishment.

S403: During secondary authentication, an IP address is allocated to the subscriber entity 200. The IP address is allocated either by the EAP server 400 or the SMF entity 300 or the UPF.

S404: Secondary authentication is executed until the EAP server 400 has authenticated the subscriber entity 200.

S405: After successful secondary authentication, the EAP server 400 sends an EAP SUCCESS message to the SMF entity 300 (acting as EAP Authenticator) indicating that the subscriber entity 200 has successfully performed secondary authentication. The subscriber entity 200 is also informed of this. The EAP server 400 might, optionally, inform the SMF entity 300 about firewall rules to apply for the PDU session, e.g., by including this information as parameters in the RADIUS/DIAMETER message carrying the EAP SUCCESS message, or using separate signaling. This information could be derived by the EAP server 400 based on any DNN requested by the subscriber entity 200 and identity authenticated to the EAP server 400 during the secondary authentication

S406: The SMF entity 300 informs the EAP server 400 about information pertaining to the authenticated subscriber entity 200, such as Generic Public Subscription Identifier (GPSI) and, optionally, the IP address allocated to the subscriber entity 200 if not done by the EAP server 400 in step S403. The SMF entity 300 might also provide information about the DNN to which the subscriber entity 200 got a PDU session established.

S407: The SMF entity obtains firewall rules for the PDU session (based on DNN), either from the EAP server 400 in step S405, or from internal databases, or configurations, and informs the UPF that the UPF should apply those firewall rules for the newly created PDU session.

S408: The UPF enables the firewall rules for the PDU session. In the present example this implies that the UPF adds firewall rules for allowing traffic to service A and service B, but not service C.

S409: At some later time, the subscriber entity 200 needs to access service C. The subscriber entity 200 therefore sends a PDU session modification request, which indicates that the subscriber entity 200 wants to add the sub-DNN for accessing service C to the current PDU session.

Alternatively, the network might initiate the PDU session modification based on a traffic flow from the subscriber entity 200 towards a service (in the present examples: service C) not authorized to be being access via the current PDU session. Thus, when the UPF receives a traffic flow to a service blocked by current firewall rules, this might trigger a network initiated PDU session modification request, where the network identifies a suitable sub-DNN that could be added to cater for the new traffic flow.

S410: The message triggers the SMF entity 300 to trigger secondary authentication for the already existing PDU session. As part of the signaling with the EAP server 400 the SMF entity 300 indicates to the EAP server 400 the sub-DNN requested by the subscriber entity 200 and, optionally, the already active DNNs and sub-DNNs for the PDU session.

The EAP server 400 might, based on information about sub-DNN and information about ongoing PDU session(s) for the subscriber entity 200 (e.g. based on previous secondary authentication(s), authentication methods used, subscriber entity identifier, etc.), select a suitable EAP method for accessing the specific sub-DNN for accessing service C.

S411: After successful secondary authentication, the EAP server 400 sends an EAP SUCCESS message to the SMF entity 300 (acting as EAP Authenticator) indicating that the subscriber entity 200 has successfully performed secondary authentication. The subscriber entity 200 is also informed of this. The EAP server 400 might, optionally. inform the SMF entity 300 about firewall rules to apply for the PDU session. This information could be derived based on DNN requested and already being used by the subscriber entity 200 and identity authenticated to the EAP server 400 during the secondary authentication.

S412: The SMF entity 300, optionally, informs the EAP server 400 about information pertaining to the authenticated UE, such as GPSI and, optionally, the IP Address of UE. The SMF entity 300 might also provide information about the DNN to which the subscriber entity 200 got a PDU Session established. This information can be used by the data network (or EAP server 400) e.g., as disclosed in step S410, or for having knowledge about identity of connected UEs in the network via an GPSI-to-IP address mapping.

S413: The SMF obtains firewall rules for the PDU session (based on DNN), either from the EAP server 400 in step S411, or from an internal database, or configurations, and informs the UPF that the UPF should apply those firewall rules for the newly modified PDU session.

S414: The UPF enables the firewall rules for the PDU session. In the present example this implies that the UPF adds firewall rule allowing traffic to service C.

It is noted that the data network could still have its own firewall for limiting incoming connections. The data network could e.g., utilize information gathered in step S412 to update its own firewall rules accordingly.

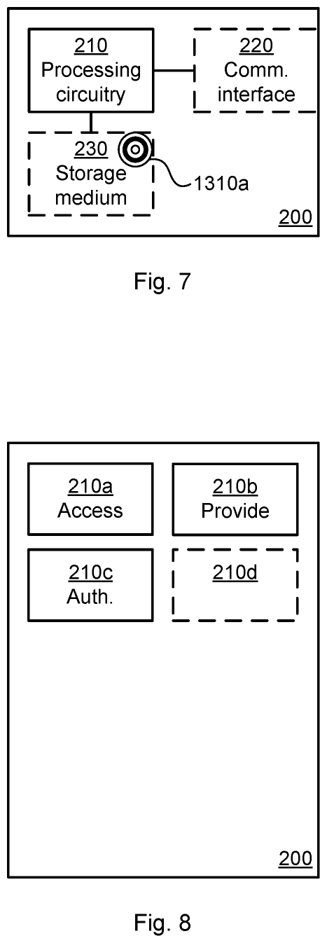

FIG. 7 schematically illustrates, in terms of a number of functional units, the components of a subscriber entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310a (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the subscriber entity 200 to perform a set of operations, or steps, as disclosed above. For example, the storage medium 230 may store the set of operations, and the processing circuitry 210 may be configured to retrieve the set of operations from the storage medium 230 to cause the subscriber entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The subscriber entity 200 may further comprise a communications interface 220 for communications with other entities, functions, nodes, and devices, as in FIG. 1. As such the communications interface 220 may comprise one or more transmitters and receivers, comprising analogue and digital components.

The processing circuitry 210 controls the general operation of the subscriber entity 200 e.g. by sending data and control signals to the communications interface 220 and the storage medium 230, by receiving data and reports from the communications interface 220, and by retrieving data and instructions from the storage medium 230. Other components, as well as the related functionality, of the subscriber entity 200 are omitted in order not to obscure the concepts presented herein.

FIG. 8 schematically illustrates, in terms of a number of functional modules, the components of a subscriber entity 200 according to an embodiment. The subscriber entity 200 of FIG. 8 comprises a number of functional modules; an access module 210a configured to perform step S102, a provide module 210b configured to perform step S104, and an authentication module 210c configured to perform step S106. The subscriber entity 200 of FIG. 8 may further comprise a number of optional functional modules, as represented by functional module 210d. In general terms, each functional module 210a:210d may be implemented in hardware or in software. Preferably, one or more or all functional modules 210a:210d may be implemented by the processing circuitry 210, possibly in cooperation with the communications interface 220 and the storage medium 230. The processing circuitry 210 may thus be arranged to from the storage medium 230 fetch instructions as provided by a functional module 210a:210d and to execute these instructions, thereby performing any steps of the subscriber entity 200 as disclosed herein.

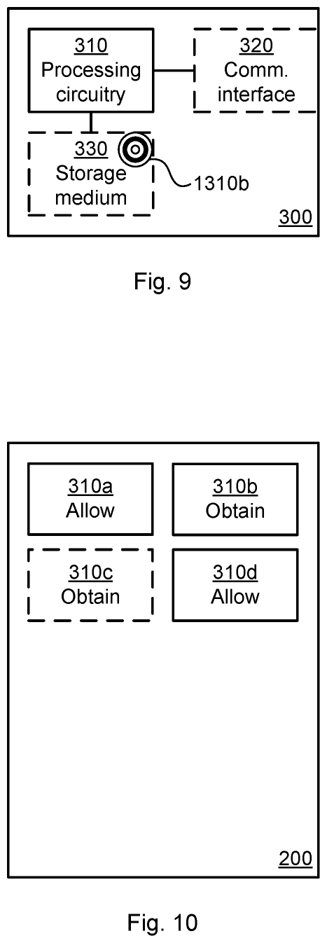

FIG. 9 schematically illustrates, in terms of a number of functional units, the components of an SMF entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1310b (as in FIG. 13), e.g. in the form of a storage medium 330. The processing circuitry 310 may further be provided as at least one application specific integrated circuit (ASIC), or field programmable gate array (FPGA).

Particularly, the processing circuitry 310 is configured to cause the SMF entity 300 to perform a set of operations, or steps, as disclosed above. For example, the storage medium 330 may store the set of operations, and the processing circuitry 310 may be configured to retrieve the set of operations from the storage medium 330 to cause the SMF entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The SMF entity 300 may further comprise a communications interface 320 for communications with other entities, functions, nodes, and devices, as in FIG. 1. As such the communications interface 320 may comprise one or more transmitters and receivers, comprising analogue and digital components.

The processing circuitry 310 controls the general operation of the SMF entity 300 e.g. by sending data and control signals to the communications interface 320 and the storage medium 330, by receiving data and reports from the communications interface 320, and by retrieving data and instructions from the storage medium 330. Other components, as well as the related functionality, of the SMF entity 300 are omitted in order not to obscure the concepts presented herein.

FIG. 10 schematically illustrates, in terms of a number of functional modules, the components of an SMF entity 300 according to an embodiment. The SMF entity 300 of FIG. 10 comprises a number of functional modules; an allow module 310a configured to perform step S202, an obtain module 310b configured to perform step S204, and an allow module 310d configured to perform step S208. The SMF entity 300 of FIG. 10 may further comprise a number of optional functional modules, such as an obtain module 310c configured to perform step S206. In general terms, each functional module 310a:310d may be implemented in hardware or in software. Preferably, one or more or all functional modules 310a:310d may be implemented by the processing circuitry 310, possibly in cooperation with the communications interface 320 and the storage medium 330. The processing circuitry 310 may thus be arranged to from the storage medium 330 fetch instructions as provided by a functional module 310a:310d and to execute these instructions, thereby performing any steps of the SMF entity 300 as disclosed herein.

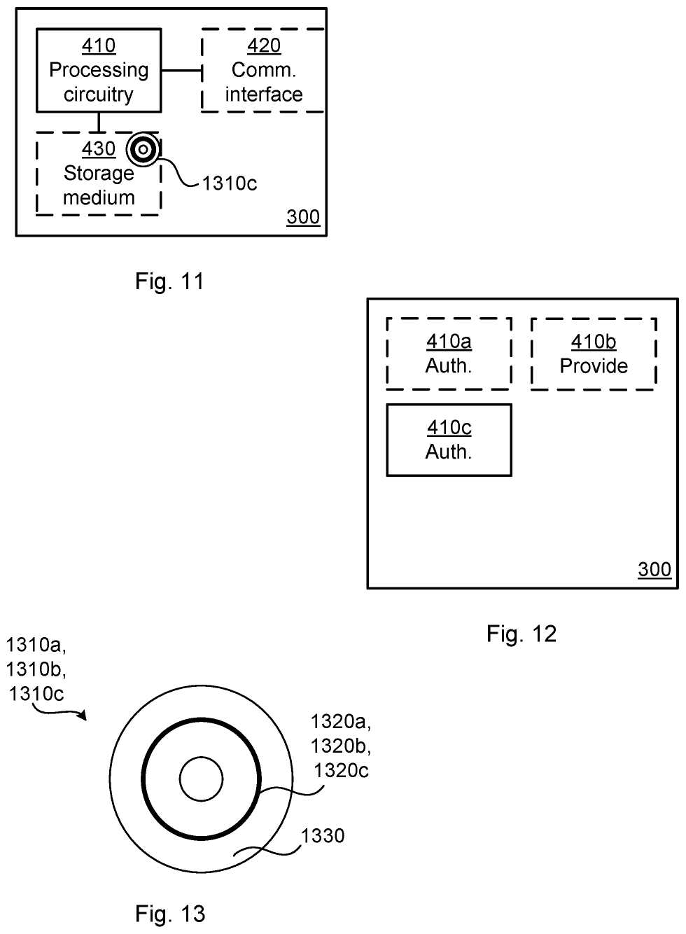

FIG. 11 schematically illustrates, in terms of a number of functional units, the components of an EAP server 400 according to an embodiment. Processing circuitry 410 is provided using any combination of one or more of a suitable central processing unit (CPU), multiprocessor, microcontroller, digital signal processor (DSP), etc., capable of executing software instructions stored in a computer program product 1310c (as in FIG. 13), e.g. in the form of a storage medium 430. The processing circuitry 410 may further be provided as at least one application specific integrated circuit (ASIC), or field programmable gate array (FPGA).

Particularly, the processing circuitry 410 is configured to cause the EAP server 400 to perform a set of operations, or steps, as disclosed above. For example, the storage medium 430 may store the set of operations, and the processing circuitry 410 may be configured to retrieve the set of operations from the storage medium 430 to cause the EAP server 400 to perform the set of operations. The set of operations may be provided as a set of executable instructions. Thus the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The EAP server 400 may further comprise a communications interface 420 for communications with other entities, functions, nodes, and devices, as in FIG. 1. As such the communications interface 420 may comprise one or more transmitters and receivers, comprising analogue and digital components.

The processing circuitry 410 controls the general operation of the EAP server 400 e.g. by sending data and control signals to the communications interface 420 and the storage medium 430, by receiving data and reports from the communications interface 420, and by retrieving data and instructions from the storage medium 430. Other components, as well as the related functionality, of the EAP server 400 are omitted in order not to obscure the concepts presented herein.

FIG. 12 schematically illustrates, in terms of a number of functional modules, the components of an EAP server 400 according to an embodiment. The EAP server 400 of FIG. 12 comprises an authentication module 410c configured to perform step S306. The EAP server 400 of FIG. 12 may further comprise a number of optional functional modules, such as any of an authentication module 410a configured to perform step S302, and a provide module 410b configured to perform step S304. In general terms, each functional module 410a:410c may be implemented in hardware or in software. Preferably, one or more or all functional modules 410a:410c may be implemented by the processing circuitry 410, possibly in cooperation with the communications interface 420 and the storage medium 430. The processing circuitry 410 may thus be arranged to from the storage medium 430 fetch instructions as provided by a functional module 410a:410c and to execute these instructions, thereby performing any steps of the EAP server 400 as disclosed herein.

The SMF entity 300 and/or the EAP server 400 may be provided as a standalone device or as a part of at least one further device. For example, the SMF entity 300 and/or the EAP server 400 may be provided in a node of the core network. Alternatively, functionality of the SMF entity 300 and/or the EAP server 400 may be distributed between at least two devices, or nodes. These at least two nodes, or devices, may either be part of the same network part (such as the core network) or may be spread between at least two such network parts. In general terms, instructions that are required to be performed in real time may be performed in a device, or node, operatively closer to the cell than instructions that are not required to be performed in real time. Thus, a first portion of the instructions performed by the SMF entity 300 and/or the EAP server 400 may be executed in a first device, and a second portion of the of the instructions performed by the SMF entity 300 and/or the EAP server 400 may be executed in a second device; the herein disclosed embodiments are not limited to any particular number of devices on which the instructions performed by the SMF entity 300 and/or the EAP server 400 may be executed. Hence, the methods according to the herein disclosed embodiments are suitable to be performed by a SMF entity 300 and/or the EAP server 400 residing in a cloud computational environment. Therefore, although a single processing circuitry 310, 410 is illustrated in FIGS. 9 and 11 the processing circuitry 310, 410 may be distributed among a plurality of devices, or nodes. The same applies to the functional modules 310a:310d, 410a:410c of FIGS. 10 and 12 and the computer programs 1320b, 1320c of FIG. 13.

FIG. 13 shows one example of a computer program product 1310a, 1310b, 1310c comprising computer readable means 1330. On this computer readable means 1330, a computer program 1320a can be stored, which computer program 1320a can cause the processing circuitry 210 and thereto operatively coupled entities and devices, such as the communications interface 220 and the storage medium 230, to execute methods according to embodiments described herein. The computer program 1320a and/or computer program product 1310a may thus provide means for performing any steps of the subscriber entity 200 as herein disclosed. On this computer readable means 1330, a computer program 1320b can be stored, which computer program 1320b can cause the processing circuitry 310 and thereto operatively coupled entities and devices, such as the communications interface 320 and the storage medium 330, to execute methods according to embodiments described herein. The computer program 1320b and/or computer program product 1310b may thus provide means for performing any steps of the SMF entity 300 as herein disclosed. On this computer readable means 1330, a computer program 1320c can be stored, which computer program 1320c can cause the processing circuitry 410 and thereto operatively coupled entities and devices, such as the communications interface 420 and the storage medium 430, to execute methods according to embodiments described herein. The computer program 1320c and/or computer program product 1310c may thus provide means for performing any steps of the EAP server 400 as herein disclosed.

In the example of FIG. 13, the computer program product 1310a, 1310b, 1310c is illustrated as an optical disc, such as a CD (compact disc) or a DVD (digital versatile disc) or a Blu-Ray disc. The computer program product 1310a, 1310b, 1310c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320a, 1320b, 1320c is here schematically shown as a track on the depicted optical disk, the computer program 1320a, 1320b, 1320c can be stored in any way which is suitable for the computer program product 1310a, 1310b, 1310c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for using a protocol data unit, PDU, session to access application services, the method being performed by a subscriber entity, the method comprising:
accessing a primary application service of a primary data network using a PDU session by first requesting the PDU session with the primary data network to be established;
providing a request to a Session Management Function, SMF, entity for the PDU session to be modified for the subscriber entity to use the PDU session to access a secondary application service with a different access control policy than the primary application service; and in response thereto:
performing a secondary authentication with an Extensible Authentication Protocol, EAP, server for the already established PDU session for the subscriber entity to access the secondary application service of the secondary data network

2. The method according to claim 1, wherein the secondary authentication is a further secondary authentication, and wherein a first secondary authentication is performed with the EAP server for accessing the primary application service.

3. The method according to claim 1, wherein the secondary application service is of a secondary data network.

4. The method according to claim 3, wherein the secondary data network is a sub-data network of the primary data network.

5. The method according to claim 3, wherein the request for the PDU session to be modified for the subscriber entity is provided in a PDU session modification request, wherein the PDU session modification request comprises an information element, IE, for at least holding information identifying the secondary data network.

6. The method according to claim 5, wherein the IE further holds information identifying that the secondary application service is requested to be accessed using the PDU session.

7. A method for enabling a subscriber entity to use a protocol data unit, PDU, session to access application services, the method being performed by a Session Management Function, SMF, entity, the method comprising:
allowing the subscriber entity to use a PDU session to access a primary application service of a primary data network upon the PDU session with the primary data network being established for the subscriber entity;
obtaining from the subscriber entity a request for the PDU session to be modified for the subscriber entity to use the PDU session to access a secondary application service with a different access control policy than the primary application servicedata; and in response thereto:
allowing the subscriber entity to access the secondary application service upon having received verification that a secondary authentication with an Extensible Authentication Protocol, EAP, server for the already established PDU session has been performed for the subscriber entity and upon having verified that the subscriber entity is allowed to use the PDU session for accessing the secondary application service.

8. The method according to claim 7, wherein the secondary authentication is a further secondary authentication, and wherein a first secondary authentication is performed with the EAP server for the subscriber entity.

9. The method according to claim 7, wherein the secondary application service is of a secondary data network.

10. The method according to claim 7, wherein the verification that the secondary authentication with the EAP server for the already established PDU session has been performed for the subscriber entity is received from the EAP server.

11. The method according to claim 7, wherein verifying that the subscriber entity is allowed to use the PDU session for accessing the secondary application service comprises the SMF entity to check policies for the PDU session.

12. The method according to claim 11, wherein the method further comprises:
obtaining the policies from the EAP server.

13-21. (canceled)

22. A subscriber entity for using a protocol data unit, PDU, session to access application services, the subscriber entity comprising processing circuitry the processing circuitry being configured to cause the subscriber entity to:
access a primary application service of a primary data network using a PDU session by first requesting the PDU session with the primary data network to be established;
provide a request to a Session Management Function, SMF, entity for the PDU session to be modified for the subscriber entity to use the PDU session to access a secondary application service with a different access control policy than the primary application servicedata; and in response thereto:
perform a secondary authentication with an Extensible Authentication Protocol, EAP, server for the already established PDU session for the subscriber entity to access the secondary application service of the secondary data network.

23. (canceled)

24. A Session Management Function, SMF, entity for enabling a subscriber entity to use a protocol data unit, PDU, session to access application services, the SMF entity comprising processing circuitry the processing circuitry being configured to cause the SMF entity to:
allow the subscriber entity to use a PDU session to access a primary application service of a primary data network upon the PDU session with the primary data network being established for the subscriber entity;
obtain, from the subscriber entity a request for the PDU session to be modified for the subscriber entity to use the PDU session to access a secondary application service with a different access control policy than the primary application servicedata; and in response thereto:
allow the subscriber entity to access the secondary application service upon having received verification that a secondary authentication with an Extensible Authentication Protocol, EAP, server for the already established PDU session has been performed for the subscriber entity and upon having verified that the subscriber entity is allowed to use the PDU session for accessing the secondary application service.

25-31. (canceled)

32. The method according to claim 2, wherein the secondary application service is of a secondary data network.

33. The method according to claim 32, wherein the secondary data network is a sub-data network of the primary data network.

34. The method according to claim 32, wherein the request for the PDU session to be modified for the subscriber entity is provided in a PDU session modification request, wherein the PDU session modification request comprises an information element, IE, for at least holding information identifying the secondary data network.

35. The method according to claim 8, wherein the secondary application service is of a secondary data network.

36. The method according to claim 35, wherein the verification that the secondary authentication with the EAP server for the already established PDU session has been performed for the subscriber entity is received from the EAP server.

37. The method according to claim 35, wherein verifying that the subscriber entity is allowed to use the PDU session for accessing the secondary application service comprises the SMF entity to check policies for the PDU session.
